(19) United States
(12) Patent Application Publication
(10) Pub. No.: US 2004/0088899 A1
(43) Pub. Date: May 13, 2004

(54) Fish strike indicator

(76) Inventors: Lawrence W. Altrich, Braintree, MA (US); Henry G. LaShoto, Waltham, MA (US)

Correspondence Address: JINAN GLASGOW, P O BOX 28539, RALEIGH, NC, 276118539

(21) Appl. No.: 10/205,162

(22) Filed: Jul. 25, 2002

(51) Int. Cl. A01K 85/01; A01K 93/00; A01K 97/12

(52) U.S. Cl. 43/17

(57) ABSTRACT

The invention provides a fish strike indicator releasably attached to a fishing line to indicate the direction a fish is swimming after it has taken the bait. The fish strike indicator includes a body and a connector and is releasably attachable to a fishing line for being suspended in air for sensing slack and tension in the line for multidirectional fish movement sensing and indication thereof. A releasable sensory indicator is present on the fish strike indicator to alert a fisherman by visual and/or audible means of a fish strike. Methods for using the fish strike indicator are also included.

### BACKGROUND OF THE INVENTION

(1) Field of the Invention

The present invention relates generally to fishing gear and, more particularly, to a fish strike indicator for people who love to go fishing.

(2) Description of the Prior Art

In the sport of fishing various fishing instrumentalities are designed to aid the fisherman in the capture of his/her prey. These include different types of fishing poles, bait and hooks. Fishing buoys or bobs are designed to float in water and to bob up and down when a fish pulls on the submerged line and swims away from the boat. In response, the user is expected to respond by grasping the fishing pole and reeling-in the hooked fish. Such bobbers can take on a variety of shapes and sizes.

Inventions relating to buoys and fishing bobbers are well known.

U.S. Pat. No. 4,139,960 to Chojnowski discloses a fishing bob which lays down while waiting for a fish to strike and which pivots upright to indicate a fish is on the line. A fishing bob and hook setting device comprising a bent wire member having a generally L-shape with vertical and horizontal sections, an eye at the junction of the two sections, and an eye at the free end of the horizontal section. The vertical section adjustably mounts a bouyant member having a flat drag surface at the top and a weight there beneath. The fishing line is threaded through the eye at the junction of the vertical and horizontal sections of the wire and is secured to the eye at the free end of the horizontal section to depend therefrom with a hook thereon. A slight downward pull by a fish tips the device to its side where the drag surface engages the water and on the occurrence of further pulling action by the fish sets the hook. The bouyant member may be frictionally adjusted on the vertical section or, the section may be threaded for vertical adjustment of a buoyant member. The horizontal section or arm of the wire may also be bent for fine adjustment

U.S. Pat. No. 4,357,775 to Click has an off-center weighted base to hold the bob in one position and can be pivoted to a second position when a fish takes the bait. It has a flexible reed slideably mounted on the weighted base at one end of the flexible reed and a bait holder secured at the other end of the flexible reed.

U.S. Pat. No 4,748,764, to Hammons discloses a fishing jigger. It is an accessory having a buoyant weighted upper body with a blade and a lower submerged body with a line and hook attached. The fishing jigger has upper and lower parts or members, the upper of which is of buoyant material constituting a water-borne support for the lower part which is an immersed or submerged blade of such weight and frontal surface area as to offer considerable resistance to horizontal displacement of the jigger when subjected to forces applied to the jigger generally normal to the aforesaid frontal area. The float is a horizontally elongated cylinder from the underside of which the blade depends to present a substantially planar area lying in the plane of the horizontal or long axis of the cylindrical float. A free-running fishing line passes through the blade for jigging a hook or lure therefrom. Pulling on the fishing line results in jiggling of the hook.

U.S. Pat. No. 5,398,440 to Amundsen provides a fishing bobber with an upward facing concave hydrodynamic drag scoop underneath a buoyant body, and structure to slip-fit a fishing line through the bobber to a non-buoyant lure. The lure may be raised and lowered while the bobber is positionally restrained by the drag scoop. A method of fishing with the bobber and scoop, and a method of making the improved bobber are provided.

U.S. Pat. No. 5,737,868 describes a floatable bobber used to support an insertable fishing line in water. The bobber has a central one-piece elongated plastic section with a T shaped slot at its lower section in which a fishing line may be inserted. Surrounding this section at its lower end is a slidable rubber sleeve used to hold the in-place fishing line. Further up the bobber is an enlarged foam section with internal weights. These weights are configured in a triangular shape with the one piece section extending through the middle of the triangle. When a fish is caught, tension is applied to the in-place fishing line to upright the attached normally prone floating bobber to indicate and alert a user to a potential catch.

These inventions do not indicate the direction a fish is swimming. For if the fish swims toward the boat or the shoreline, wherever the fisherman is fishing, then slack is not taken up and the fisherman is at a loss as to whether or not a fish has taken the bait. Thus there remains a need for a simple fish strike indicator device to indicate the direction the fish is swimming with the baited hook. Moreover past devices provide no sensory alert to a fisherman. Thus there also remains a need for a sensory device to alert a fisherman of a fish strike. The present invention solves these needs to indicate the direction a fish is swimming after it strikes so that the hook can be set before the fish has taken the bait and spits out the hook.

### SUMMARY OF THE INVENTION

The present invention is directed to a fish strike indicator slideably attached to a fishing line to indicate to a fisherman the direction a fish is swimming after it has taken the bait. It is one aspect of the present invention to provide a fish strike indicator that is capable of sensing both slack and tension in a fishing line for sensing and indicating multidirectional fish movement.

In one embodiment, the fish strike indicator includes a substantially hourglass-shaped, and preferably made of piece of cork or other lightweight material.

A further aspect of the present invention provides a fish strike indicator that is made of two shaped lightweight forms conjoined at their ends and releasably attachable to a fishing line for being suspended in air for sensing slack and tension in the line for multidirectional fish movement sensing and indication thereof. Another aspect of the present invention is the presence of a releasable sensory indicator on the fish strike indicator. It is another aspect of the invention to provide a method of using the fish strike indicator.

These and other aspects of the present invention will become apparent to those skilled in the art after a reading of the following description of the preferred embodiment when considered with the drawings.

### BRIEF DESCRIPTION OF THE DRAWINGS

FIG. 1 is a front view of one embodiment of the invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

Referring now to the drawings in general, the illustrations are for the purpose of describing a preferred embodiment of the invention and are not intended to limit the invention thereto.

The preferred embodiment generally referred to includes of a lightweight, shaped body with a connector attached thereto for releasable attachment to a fishing line.

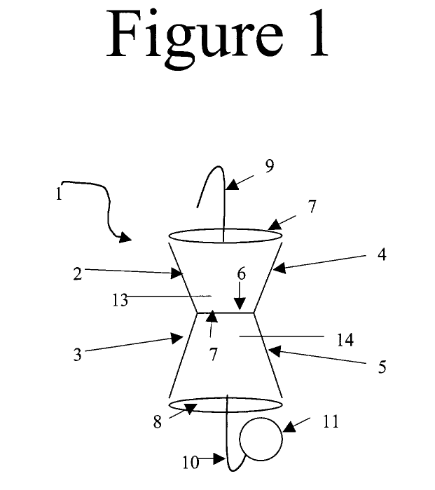

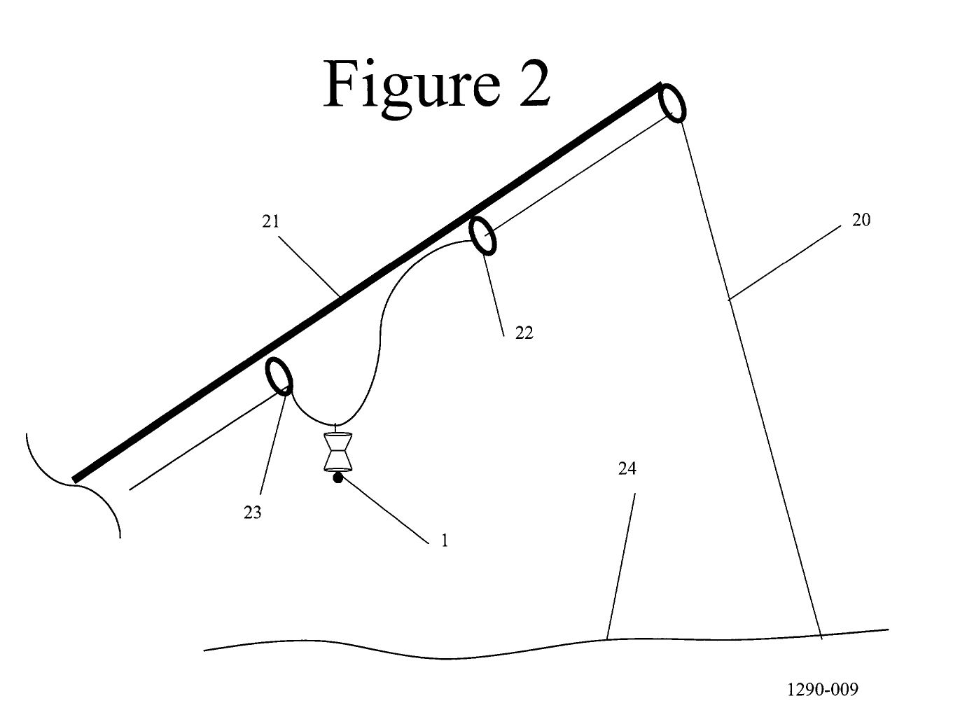

As seen in FIG. 1, in a preferred embodiment of the present invention, a fish strike indicator 1 is shown made of top and bottom invertedly shaped lightweight forms, 13 and 14 respectively, conjoined at their inverted ends, 6 and 7 respectively, and releasably attachable to a fishing line for being suspended in air from a fishing line 20, connected to a fishing rod 21, preferably on a line segment between two eyelets 22, 23 through which the line is threaded, wherein the fish strike indicator is constructed and positioned for sensing slack and tension in the line for multidirectional fish movement sensing and indication thereof. In an alternative embodiment, the body is formed of a unitary, lightweight material.

Preferably, the body is lightweight; in one preferred embodiment, the body weighs approximately ⅛ ounce for freshwater bottom fishing and could be heavier for salt water bottom fishing. Generally, it is preferred that the lightweight body be between about 1/16 ounce to about one ounce, depending upon the application, i.e., fresh or salt water, the weight of fishing line used, and the type of fish expected to be caught.

The fish strike indicator slideably attached to a fishing line to indicate to a fisherman the direction a fish is swimming after it has taken the bait. In FIG. 1, the fish strike indicator is slideably attached to a hook 9.

In a more preferred embodiment a releasable sensory indicator is releasably present on the fish strike indicator. Preferably, the indicator provides audible sensing of the strike by being activated by motion, either slack or tension, in the fishing line. The sensory indicator may indicate a fish has taken the bait by visual and/or audible means. The indicator is set-off when a fish strikes the bait, is hooked, or causes a significant movement of the fish strike indicator on the fishing line. Visual means includes a light, a flashing light such as an LED light, constant light supplied by power by a battery, snap-glow stick, which is activated by a chemical reaction, or glow-in the dark material that fades with time; in the case of a constant light or a fades-over-time light, the light is provided for the fisherman to view the motion or non-motion of the fish strike indicator device as it is suspended from the fishing line. Audible means includes a bell or electronic beeping sound or any sound that can be heard by the user. In FIG. 1, a bell indicator 11 is attached to the fish strike indicator by a hook 10 and can be removed in windy weather conditions or when a sound may scare off fish or annoy neighboring fishermen.

Another preferred embodiment is a method of using a fish strike indicator. A method for using a fish strike indicator as set forth hereinabove includes providing a fishing rod with a fishing line and connecting a fish strike indicator device to a fishing line on the rod between two eyelets with a certain amount of slack in the line therebetween.

Certain modifications and improvements will occur to those skilled in the art upon a reading of the foregoing description. All modifications and improvements have been deleted herein for the sake of conciseness and readability but are properly within the scope of the following claims.

We claim:

1. A fishing device for sensing and indicating a fish strike comprising a body and a connector affixed to one end of the body for releasable attachment to a fishing line for sensing slack and tension in the line relating to multidirectional movement of a fish and indication thereof.

2. The fishing device according to claim 1 wherein the device is segmented.

3. The fishing device according to claim 3 wherein the device is made of two invertedly shaped lightweight forms,
each lightweight form having top and bottom ends
wherein the two lightweight forms are conjoined at their smaller inverted ends.

4. The fishing device according to claim 1 wherein a sensory indicator is releasably attached.

5. The fishing device according to claim 4 wherein the sensory indicator is a visual sensory device.

6. The fishing device according to claim 4 wherein the sensor indicator is an audible sensory device.

7. The fishing device according to claim 1, wherein the device is made of a unitary, lightweight body.

8. A method for using a fish strike indicator device comprising the following steps
(a) providing a fishing rod with a fishing line; and
(b) releasably connecting the device of claim 1 to a fishing line to indicate a fish strike.
